(19) United States
(12) Patent Application Publication
(10) Pub. No.: US 2011/0027657 A1
(43) Pub. Date: Feb. 3, 2011

(54) NONAQUEOUS ELECTROLYTE SECONDARY BATTERY

(75) Inventors: Shumpei NISHINAKA, Osaka-shi (JP); Naoto NISHIMURA, Osaka-shi (JP); Kazuya SAKASHITA, Osaka-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/844,271

(22) Filed: Jul. 27, 2010

(30) Foreign Application Priority Data
Jul. 28, 2009 (JP) 2009-175532

(51) Int. Cl. H01M 4/60; H01M 2/14

(52) U.S. Cl. 429/246; 429/212

(57) ABSTRACT

A nonaqueous electrolyte secondary battery including a positive electrode, a negative electrode and a separator between the positive electrode and the negative electrode, in which at least one of the positive electrode and the negative electrode has an active material layer containing a material whose electric resistance increases at a high temperature, and the material is unevenly distributed in proximity to the separator of the active material layer.

### BACKGROUND OF THE INVENTION

1. Field of the Invention

The present invention relates to a nonaqueous electrolyte secondary battery. More specifically, the present invention relates to a nonaqueous electrolyte secondary battery with a high capacity, which is high in safety.

2. Description of the Related Art

A nonaqueous electrolyte secondary battery typified by a lithium-ion secondary battery (hereinafter referred to simply as a secondary battery) has been widely utilized for consumer products since it has a high capacity and a high energy density and being excellent in storage performance and cycling characteristics of charge and discharge. On the other hand, sufficient measures for safety are required for the secondary battery since a lithium metal and a nonaqueous electrolytic solution are used in the battery.

For example, in the case where short circuit occurs by some cause between a positive electrode and a negative electrode of the secondary battery having a high capacity and a high energy density, an excessive short-circuit current flows between the positive electrode and the negative electrode. The short-circuit current generates Joule's heat by an internal resistance of the secondary battery to raise the temperature of the secondary battery, so that the secondary battery falls into an abnormal state (such as ignition). In particular, it is desired for the secondary battery using the nonaqueous electrolytic solution to be prevented from falling into an abnormal state, and the battery is generally provided with a preventing function.

The secondary battery in which an electronically conductive material composed of a conductive filler and a resin is mixed in the whole active material layer of the positive electrode and/or the negative electrode is reported as the preventing function in Japanese Unexamined Patent Publication No. 2002-42886. In this publication, when abnormal heat generation occurs by the short circuit due to mixing of a foreign matter between the positive electrode and the negative electrode, the resin is molten to increase an electric resistance of the active material layer. As a result of increase of the electric resistance, the short-circuit current may be decreased, so that it is conceived that temperature rise may be restrained to improve the safety.

Also, it is proposed in Japanese Unexamined Patent Publication No. HEI 11 (1999)-102711 that a current collector with a three-layer structure in which a resin film layer with a melting point of 130 to 170° C. is sandwiched between metal layers is used for the positive electrode and/or the negative electrode. In a battery provided with this current collector, in the case where abnormal heat generation occurs by a short circuit current, the resin film is molten down and the metal layers sandwiching the resin film are also broken. The short circuit current is cut by the breakage of the metal layers, and the temperature rise inside the secondary battery is restrained, so that it is conceived that ignition may be prevented.

### SUMMARY OF THE INVENTION

Thus, according to the present invention, there is provided a nonaqueous electrolyte secondary battery comprising:

a positive electrode;

a negative electrode; and

a separator between the positive electrode and the negative electrode; wherein

at least one of the positive electrode and the negative electrode has an active material layer containing a material whose electric resistance increases at a high temperature and

the material is unevenly distributed in proximity to the separator of the active material layer.

### EFFECT OF THE INVENTION

The secondary battery of the present invention is provided with a positive electrode, a negative electrode and a separator between the positive electrode and the negative electrode, and at least one of the positive electrode and the negative electrode is provided with an active material layer containing a material whose electric resistance increases at a high temperature (hereinafter referred to as a material with increased resistance at high temperature), and the material is unevenly distributed in proximity to the separator of the active material layer. With regard to the secondary battery provided with this constitution, abundant presence of the material with increased resistance at high temperature in proximity to the separator of the active material layer allows a response of an electric resistance increase to the abnormal heat generation to be quickened when the positive electrode and the negative electrode are internally short-circuited by a foreign matter compared to the case of imparting a function of restraining the short circuit current to the current collector. Also, in the case of thickening the active material layer for achieving a higher capacity, a reduction in a response speed to the electric resistance increase may be restrained from decreasing.

In the case where the material with increased resistance at high temperature is contained by 90% by weight or more of the total amount thereof in the active material layer within a thickness up to 30% from the separator side with respect to the total thickness, the response of the electric resistance increase to the abnormal heat generation may be further quickened when the positive electrode and the negative electrode are internally short-circuited.

In addition, in the case where the material with increased resistance at high temperature contains a conductive material and a resin that increases the electric resistance by melting at a high temperature, the response of the electric resistance increase to the abnormal heat generation may be further quickened when the positive electrode and the negative electrode are internally short-circuited.

Also, in the case where the material with increased resistance at high temperature contains a resin that melts at a high temperature of at least 120° C. and at most 160° C., the response of the electric resistance increase to the abnormal heat generation may be further quickened when the positive electrode and the negative electrode are internally short-circuited.

In addition, in the case where the material with increased resistance at high temperature contains a particulate resin, the active material layer contains a particulate active material, and the resin has an average particle diameter of at least 10% of an average particle diameter of the active material and at most 50 μm, the response of the electric resistance increase to the abnormal heat generation may be further quickened when the positive electrode and the negative electrode are internally short-circuited.

Also, in the case where the material with increased resistance at high temperature contains a conductive material selected from graphite, aluminum, stainless steel, titanium, copper, nickel and gold and a resin that melts at a high temperature selected from polyethylene, polypropylene and a copolymer of ethylene and propylene, the response of the electric resistance increase to the abnormal heat generation may be further quickened when the positive electrode and the negative electrode are internally short-circuited.

In addition, when the active material layer has a voidage in a range of 15 to 80%, a more favorable battery characteristic is exhibited under ordinary charge and discharge, particularly, under a high output (high current of 0.2 C or more). Here, a current of 1 C denotes a current value which may be fully charged in 1 hour.

### BRIEF DESCRIPTION OF THE DRAWINGS

FIGS. 1A to 1C are schematic views illustrating a mechanism of increase of the electric resistance against the abnormal heat generation of a secondary battery of the present invention;

FIG. 2 is a schematic view showing an embodiment of a secondary battery of the present invention;

FIG. 3 is a schematic view showing an active material layer composing a secondary battery of the present invention, which is composed of a laminated structure of a negative electrode active material layer, a mixed layer of a negative electrode active material and a material with increased resistance at high temperature, and a layer of the material with increased resistance at high temperature from the current collector side;

FIG. 4 is a graph showing a relationship between a discharge rate and a discharge characteristic of Example 1 and Comparative Example 1; and

FIGS. 5A and 5B are graphs showing a relationship between a voidage and a discharge rate capacity ratio of Example 2.

### DETAILED DESCRIPTION OF THE PREFERRED EMBODIMENTS

A secondary battery used for automobiles and at home is frequently placed outdoors, and an ambient temperature is assumed to reach approximately 60° C. under the flaming sun. A resin composing an electronically conductive material is mixed in an active material layer in Japanese Unexamined Patent Publication No. 2002-42886. This resin may have a bad influence on the battery characteristic since it expands in the volume under an environment of approximately 60° C. to increase the electric resistance of the active material layer.

In Japanese Unexamined Patent Publication No. HEI 11 (1999)-102711, a function of preventing short circuit is imparted to a current collector, so that the heat generation by the short circuit current is required until a resin film composing the current collector is molten down. However, it is desirable that the short circuit current is restrained at an earlier stage from the viewpoint of further improving the safety.

The inventors of the present invention have reached the present invention by finding out that a function of cutting an abnormal current due to internal short circuit may be imparted to an electrode by intensively unevenly distributing a material whose electric resistance increases at a high temperature (hereinafter referred to as a material with increased resistance at high temperature) in proximity to a separator of a positive electrode active material layer and/or negative electrode active material layer. The inventors have also found out that the unevenly distribution allows an influence of the material with increased resistance at high temperature on the battery characteristic to be lessened under an environment of an ordinary battery working temperature (for example, approximately 60° C.).

The present invention is hereinafter described based on the drawings. In the following drawings, the same reference numerals are imparted to the same or corresponding portions, and the description thereof is not repeated. Measurements such as a length, a size and a width in the drawings are properly modified for clarification and simplification of the drawings, and occasionally may not denote real measurements. The diameter of particles in an negative electrode and a positive electrode, and a resin particle is a value measured by using a particle diameter distribution measuring apparatus SALD-1100 (manufactured by Shimadzu Corp.). The voidage Z % described herein denotes a value calculated by Z=100×((1/Y)−(1/X))/(1/Y), wherein the true density and the real density of the active material layer are denoted by X g/cc and Y g/cc, respectively.

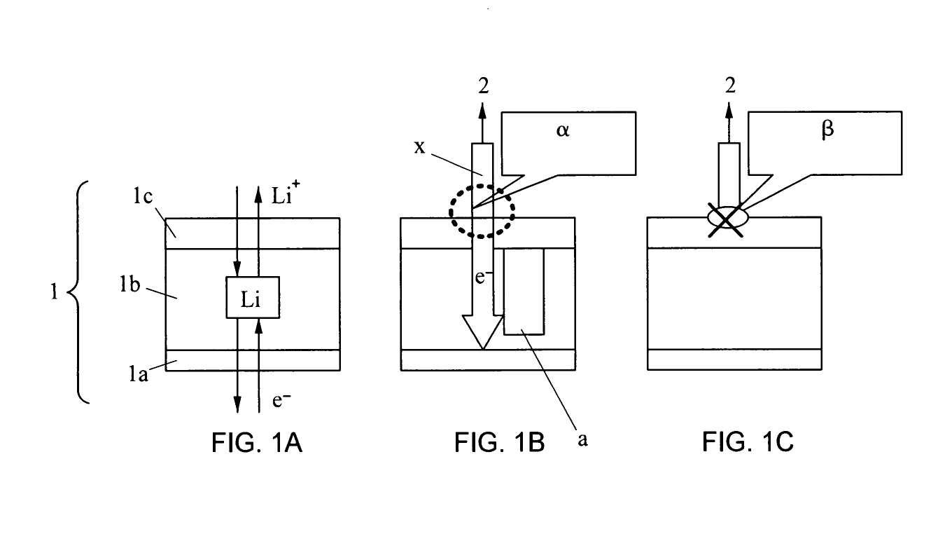

First, the mechanism of an increase in the electric resistance against the abnormal heat generation of the secondary battery of the present invention is described with reference to FIGS. 1A to 1C. These drawings show a case where the material with increased resistance at high temperature is contained on the negative electrode side. First, FIG. 1A shows a situation of charge and discharge at an ordinary temperature, and lithium is normally exchanged between the positive electrode and the negative electrode. In the drawing, 1 denotes the negative electrode, 1a denotes a current collector, 1b denotes the active material layer, and 1c denotes a layer with increased resistance at high temperature. Next, FIG. 1B shows a situation immediately after a foreign matter X passed through the separator to short-circuit the positive electrode 2 and the negative electrode 1. In a spot a in which the positive electrode 2 and the negative electrode 1 are short-circuited by the foreign matter X, a large current a flows between the positive electrode 2 and the negative electrode 1 and heat generates in the spot α. In addition, FIG. 1C shows a situation awhile after the heat generation. In FIG. 1C, the material with increased resistance at high temperature present in the spot a where heat generates in FIG. 1B shuts down the current flowing between the positive electrode 2 and the negative electrode 1 by increasing the electric resistance between the positive electrode 2 and the negative electrode 1 via the spot α. As a result, the heat generation may be restrained. In FIG. 1C, β means a spot where the electric resistance increases.

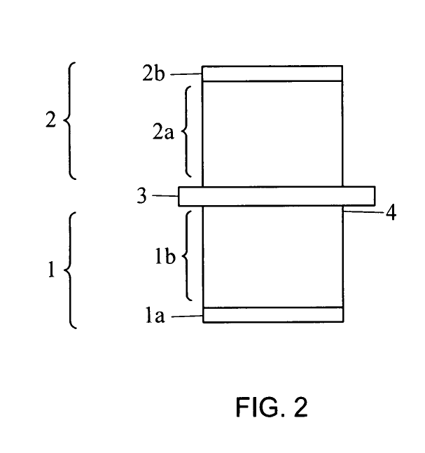

Next, FIG. 2 shows a schematic view showing an embodiment of the secondary battery of the present invention. The secondary battery of the present invention is provided with the positive electrode 2, the negative electrode 1, and the separator 3 between the positive electrode 2 and the negative electrode 1.

The negative electrode 1 usually has a structure in which the negative electrode active material layer 1b is fixed on the current collector 1a. The positive electrode 2 usually has a structure in which the positive electrode active material layer 2b is fixed on the current collector 2a. The separator 3 intends electrical insulation between the positive electrode 2 and the negative electrode 1, and has a role of ensuring ionic conduction between the positive electrode 2 and the negative electrode 1 by retaining an electrolytic solution. FIG. 2 shows a case where a material with increased resistance at high temperature 4 is unevenly distributed on the negative electrode active material layer 1b side in proximity to an interface between the negative electrode active material layer 1b and the separator 3.

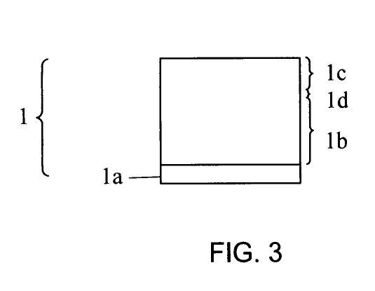

FIG. 3 shows another example of the structure of the negative electrode 1. FIG. 3 shows the active material layer composed of a laminated structure of the negative electrode active material layer 1b, a mixed layer 1d of the negative electrode active material and the material with increased resistance at high temperature, and the layer with, increased resistance at high temperature 1c from the current collector 1a side. In FIG. 3, the material with increased resistance at high temperature is present as the layer 1c on the separator side, so that the material with increased resistance at high temperature is unevenly distributed in the active material layer.

As shown in FIG. 3, the material with increased resistance at high temperature needs not clearly be present as the layer 1c, and a density of the material with increased resistance at high temperature may be continuously increased toward the separator side as shown in FIG. 2.

FIGS. 1 and 2 show a case where the material with increased resistance at high temperature is unevenly distributed only on the negative electrode active material layer side; yet, the material with increased resistance at high temperature may be unevenly distributed only on the positive electrode active material layer side, or the material with increased resistance at high temperature may be unevenly distributed on both the positive electrode active material layer and the negative electrode active material layer. The material with increased resistance at high temperature is intensively unevenly distributed in proximity to the separator of the positive electrode active material layer and/or the negative electrode active material layer, so that the response of the electric resistance increase to the abnormal heat generation may be quickened when the positive electrode and the negative electrode are internally short-circuited by a foreign matter compared with the case of a conventional technique using the resin film for the current collector. The response speed of the electric resistance increase does not depend on a thickness of the active material layer since a region of the electric resistance increase is unevenly distributed on the separator side. Accordingly, even in the case of thickening the active material layer for achieving a higher capacity, the response speed of the electric resistance increase does not slow down.

(Positive Electrode)

The positive electrode may be produced, for example, by applying and drying a paste containing the positive electrode active material, a conductive agent, a thickening material and a binder to the current collector. The produced positive electrode may be pressed for increasing an active material density.

<Positive Electrode Active Material>

Examples of the positive electrode active material include oxides containing lithium. Specific examples thereof include LiCoO₂, LiNiO₂, LiFeO₂, LiMnO₂, LiMn₂O₄, and a compound obtained by partially substituting a transition metal in these oxides with another metallic element. Above all, in an ordinary use, an oxide in which 80% or more of the lithium amount in the positive electrode may be utilized for a battery reaction is preferably used for the positive electrode active material. Such a positive electrode active material may improve the safety of the battery against an accident such as overcharge. Examples of such a positive electrode active material include compounds having a spinel structure, such as LiMn₂O₄, and compounds having an olivine structure represented by LiMPO₄ (M is an element of at least one kind or more selected from Co, Ni, Mn and Fe). Above all, the positive electrode active material containing Mn and/or Fe is preferable from the viewpoint of decreasing the cost. In addition, LiFePO₄ is preferable from the viewpoint of safety and a charging voltage. LiFePO₄ is excellent in safety for the reason that all oxygen atoms bond to phosphorus by a firm covalent bond and emission of oxygen by temperature rise is hardly caused. Since LiFePO₄ contain phosphorus, an anti-inflammatory action can also be expected.

The positive electrode active material usually has a shape of a particle. With regard to a particle diameter thereof, too small a particle diameter brings about a malfunction such that the particle passes through the separator, and too large a particle diameter occasionally makes formation of the positive electrode difficult. Therefore, the particle diameter of the positive electrode active material is preferably in a range of 0.2 to 50 μm.

The positive electrode preferably has a voidage in a predetermined range to retain an electrolytic solution. The voidage of the positive electrode obtained by drying the positive electrode paste is ordinarily in a range of 40 to 80%. Even in the case of pressing the paste after drying, the voidage is preferably in a range of 15 to 50% in consideration of electrical conductivity and an electrolytic solution retention rate of the positive electrode. These ranges of the voidage are particularly effective in the case of operating the secondary battery under a high output (high current of 0.2 C or more).

<Binder>

The binder is not particularly limited as long as it may bind the positive electrode active material particles as well as the positive electrode active material particles and the current collector, and is stable in an electric potential during the battery charge and discharge. Examples of the binder include a styrene-butadiene rubber and polyvinylidene fluoride. With regard to the binder, a small amount of addition thereof deteriorates binding force, and a large amount of addition raises a battery resistance. Therefore, for example, in the case of using a styrene-butadiene rubber for the binder, the amount of addition of the binder is preferably 0.5 to 8 parts by weight with respect to 1 part by weight of the positive electrode active material.

<Thickening Material>

In the case of using a binder of an aqueous dispersion type such as a styrene-butadiene rubber, the thickening material is preferably added for retaining dispersion of the positive electrode active material particles to facilitate application of the paste to the current collector. The thickening material, which may ensure dispersibility and ease of application and is stable in an electric potential during the battery charge and discharge, is preferably used. Examples of the thickening material include carboxymethyl cellulose. The amount of addition of the thickening material varies depending on a kind and production conditions thereof; however, the amount of addition of the thickening material is preferably 0.5 to 2 parts by weight with respect to 1 part by weight of the positive electrode active material in consideration of the dispersibility and the viscosity in applying of the positive electrode active material.

<Current Collector>

Examples of the material for the current collector include aluminum, stainless steel, titanium, copper and nickel. Aluminum is preferable for the positive electrode in consideration of electrochemical stability, stretchability and economy. Examples of a shape of the current collector include a foil shape, but the shape thereof is not limited thereto. The shape except the foil shape does not have to be a plane such as the foil shape and a three-dimensional structure can also be used to maintain current collectability and the shape in the case of thickening the positive electrode for achieving a higher capacity, for example.

(Negative Electrode)

The negative electrode may be produced, for example, by applying and drying a paste containing the negative electrode active material, a conductive agent, a thickening material and a binder to the current collector. The produced negative electrode may be pressed for increasing an active material density.

<Negative Electrode Active Material>

The active material having properties of occluding a lithium ion in charging and emitting it in discharging may be used as the negative electrode active material. Specific examples of the negative electrode active material include natural graphite, particulate (such as flake-like, block-like, fibrous, whisker-like, spherical or granular) artificial graphite, highly crystalline graphite (a graphite carbon material) typified by a graphitized product such as a mesocarbon microbead, a mesophase pitch powder or an isotropic pitch powder, and non-graphitizable carbon such as resin baked carbon. These negative electrode active materials may be used by mixing. An oxide of tin, a silicon-based negative electrode active material (such as SnO or SiO), and an alloy-based negative electrode active material with the large capacity (such as a lithium alloy) may also be used. Above all, the graphite carbon material is preferable in being capable of achieving higher energy density for the reason that the electric potential of the charge and discharge reaction is high in flatness and close to a dissolution-deposition potential of the metal lithium. In addition, the graphite carbon material with amorphous carbon adhered to the surface is preferable in being capable of restraining the decomposition reaction of the nonaqueous electrolyte associated with charge and discharge to decrease gas generation in the battery.

The average particle diameter of the graphite carbon material as the negative electrode active material is preferably 2 to 50 μm, more preferably 5 to 30 μm. An average particle diameter less than 2 μm may occasionally makes the negative electrode active material pass through a pore of the separator and the negative electrode active material passed therethrough may occasionally short-circuits the battery. On the other hand, an average particle diameter more than 50 μm may occasionally makes molding of the negative electrode difficult. In addition, a specific surface area of the graphite carbon material is preferably 1 to 100 m²/g, more preferably 2 to 20 m²/g. A specific surface area less than 1 m²/g may occasionally decreases the region for allowing the insertion/elimination reaction of lithium to deteriorate high-current discharge performance of the battery. On the other hand, a specific surface area more than 100 m²/g may occasionally increases a place where the decomposition reaction of the nonaqueous electrolyte on the negative electrode active material surface occurs, to cause gas generation in the battery. Here, in the present invention, the average particle diameter and the specific surface area are values measured by using an automatic gas/vapor absorbed amount measuring apparatus BELSORP18 manufactured by BEL Japan, Inc.

In the case of using the copper foil current collector, the thickness of the negative electrode active material layer is preferably in the range of 20 to 200 μm from the viewpoint of a battery capacity and an electrode resistance. However, this may not apply to the case of modifying the current collector structure. With regard to the voidage of the negative electrode, the voidage in the case of drying the negative electrode paste is ordinarily 40 to 80% and the electrode is molded by pressing this, in which case the voidage is preferably 15 to 50% in consideration of electrical conductivity and an electrolytic solution retention rate of the electrode. These ranges of the voidage are particularly effective in the case of operating the secondary battery under a high output (high current of 0.2 C or more).

<Conductive Agent, Thickening Material and Binder>

The conductive agent, the thickening material and the binder of the same kind as in the positive electrode may be used for the conductive agent, the thickening material and the binder, respectively, and the used amount thereof may also be the same as in the positive electrode.

<Current Collector>

Examples of the material and shape of the current collector include the material and shape of the same kind as the current collector of the positive electrode. Copper is preferable for the negative electrode in consideration of electrochemical stability, stretchability and economy.

(Material with Increased Resistance at High Temperature)

The material whose electric resistance increases at a high temperature (the material with increased resistance at high temperature) is contained in at least one of the active material layers of the positive electrode and the negative electrode. The material with increased resistance at high temperature may be contained in the active material layers of both the positive electrode and the negative electrode.

The material with increased resistance at high temperature is not particularly limited as long as it is a material whose electric resistance increases a high temperature. The high temperature herein, for example, means a higher temperature than the ordinary working temperature of the secondary battery, the increase of which is due to the abnormal heat generation caused by the short-circuit current flowed by the short circuit of the positive electrode and the negative electrode. Specifically, it is preferable that the ordinary working temperature is −20 to 60° C. and the high temperature is 120 to 160° C. The degree of the electric resistance increase at a high temperature is preferably at least three times of the electric resistance at the ordinary working temperature. The resistance value of the material with increased resistance at high temperature at the ordinary working temperature is preferably 0.05 to 10 Ω·cm; the resistance values within this range do not hinder the function of the secondary battery at the ordinary working temperature, and may restrain the short-circuit current from generating only at a high temperature.

A conductive material and a resin that melts at a high temperature are preferably contained in the material with increased resistance at high temperature. The inclusion of the conductive material may restrain the electric resistance of the active material layer from increasing at the ordinary working temperature. A material with a resistance value of 10⁻⁴ to 10 Ω·cm may be used as the conductive material. Examples of the conductive material include graphite, aluminum, stainless steel, titanium, copper, nickel and gold.

The resin that melts at a high temperature preferably contains one kind or more of the resin that melts at a temperature of 120 to 160° C. Examples of the resin include polyethylene, polypropylene and a copolymer of ethylene and propylene.

In order to sufficiently increase the electric resistance on the occasion of the abnormal heat generation, the material with increased resistance at high temperature preferably contains the resin that melts at a high temperature by 70% by weight or more of the total amount.

Any shape such as a spherical or filler-like shape may be used as the shape of the resin that melts at a high temperature. Among them, the spherical shape which is easy in uniform mixing into the active material layer is preferable. When the particle diameter of the resin is too small as compared with that of the active material particle, the incorporation of the resin particle into a gap between the active material particles may raise a possibility that the electric resistance is not sufficiently increased on the occasion of the abnormal heat generation. Therefore, the particle diameter of the resin is preferably at least 10% of the particle diameter of the active material particle. When the particle diameter of the resin is too large, the active material layer is hardly formed; therefore, the particle diameter of the resin is preferably at most 50 μm, more preferably 10 to 30 μm.

The resin that melts at a high temperature is preferably a resin which makes the electric resistance of the material with increased resistance at high temperature lower than the forming material of the active material layer and imparts a voidage such, as not to hinder ion migration in the electrolytic solution to the active material layer in charge and discharge at the ordinary temperature. Specifically, the resin is desirably a resin which reduces the electric resistance of the material with increased resistance at high temperature by 50% or more than the forming material of the active material layer, and imparts a voidage of 15% or more to the active material layer. The voidage is preferably 80% or less from the viewpoint of retention of an electronic transfer rate in the layer and maintenance of the structure of the layer.

The conductive material is particulate for example, and may be used by mixing with the particle of the resin that melts at a high temperature, or in the form that the material covers the particle of the resin that melts at a high temperature.

The material with increased resistance at high temperature is preferably contained by 90% by weight or more of the total amount thereof in the active material layer within the thickness up to 30% from the separator side with respect to the total thickness.

The thickness up to 30% from the separator side is preferably 0.5 μm or more in consideration of the particle diameter of the particle of the general resin that melts at a high temperature. When the thickness up to 30% from the separator side is too thick, extension of the distance between the positive and negative electrodes occasionally increases the electric resistance of the secondary battery. Therefore, the upper limit of the thickness up to 30% from the separator side is preferably 2000 μm. In addition, it is preferable in consideration of the influence on the characteristic of the secondary battery that a portion containing 90% by weight or more of the total amount is the thickness of 10 to 30% with respect to the thickness of the active material layer and that the portion has the voidage of 15% or more.

A method of unevenly distributing the material with increased resistance at high temperature in proximity to the separator is not particularly limited and the following method is exhibited. First, the positive electrode and/or negative electrode pastes are applied to the current collector and subsequently dried to obtain positive electrode and/or negative electrode paste layers. Subsequently, the paste containing the material with increased resistance at high temperature is applied to the positive electrode and/or negative electrode paste layers and subsequently dried to obtain a layer of a material paste with increased resistance at high temperature. The positive electrode and/or the negative electrode in which the material with increased resistance at high temperature is unevenly distributed in proximity to the separator may be obtained by pressing the positive electrode and/or negative electrode paste layers and the layer of a material paste with increased resistance at high temperature as required.

A conductive agent, a thickening material and a binder of the same kind as the positive electrode may be contained in the paste containing the material with increased resistance at high temperature. The used amount of the conductive agent, the thickening material and the binder may be 0.05 to 0.4 parts by weight, 0.005 to 0.02 parts by weight and 0.005 to 0.08 parts by weight respectively with respect to 1 part by weight of the material with increased resistance at high temperature.

(Separator)

With regard to the separator, any separator known in this field may be used as long as it is high in ion permeability, has a predetermined mechanical strength and is an insulating thin film. An olefin resin, a polyester resin, a fluororesin, a polyimide, a polyamide (nylon), a cellulosic resin and a glass fiber are used as the material thereof. Examples of the form thereof include a nonwoven fabric, a woven fabric and a microporous film.

The resin composing the separator is preferably unaffected by an electrolytic solution. Examples thereof include polyolefin resins such as polyethylene, polypropylene and poly-4-methylpentene-1, polyester resins such as polyethylene terephthalate, polybutylene terephthalate, polyethylene naphthalate and polytrimethylene terphthalate, polyamide resins such as 6-nylon, 66-nylon and a wholly aromatic polyamide, and a cellulosic resin. The separator may be composed of one kind, or two kinds or more of them.

The separator is preferably selected from nonwoven fabrics and microporous films such as polyethylene, polypropylene and polyester in view of stability of the quality. The nonwoven fabric and the microporous film can impart to the secondary battery a function (shutdown), that the separator melts by heat to intercept between the positive and negative electrodes in the case where the secondary battery generates heat abnormally.

It is preferable for improving the safety of the secondary battery that the resin used for the separator has a higher softening point (a temperature at which the shape does not change) than the melting point of the resin that melts at a high temperature. This temperature relationship allows the shutdown in such a manner that the resin that melts at a high temperature melts before the shutdown function of the separator operates. Therefore, the resin used for the separator preferably causes no shape changes at the temperature of 0 to 160° C. For example, a polyimide and a polyamide are so excellent in form-stability as to have a merit of being stable in the form even when the temperature rises. The softening point of the resin used for the separator is preferably higher by 40° C. or more than the melting point of the resin that melts at a high temperature.

The thickness of the separator is not particularly limited and may a the thickness capable of retaining the needed amount of the electrolytic solution and preventing the short circuit of the positive electrode and the negative electrode. For example, the thickness is approximately 0.01 to 1 mm, preferably approximately 0.02 to 0.05 mm. The material composing the separator preferably has a gas permeability of 1 to 500 seconds/cm³ for being capable of ensuring the strength for preventing the internal short circuit while maintaining the low internal resistance.

(Nonaqueous Electrolytic Solution)

The nonaqueous electrolytic solution is ordinarily contained in the secondary battery. Examples of the nonaqueous electrolytic solution include a solution obtained by dissolving an electrolyte salt in an organic solvent.

The electrolyte salt is preferably one that has lithium as a cationic component in the case of using the lithium-ion secondary battery; examples thereof include a lithium salt having an organic acid as an anionic component, such as lithium borofluoride, lithium hexafluorophosphate, lithium perchlorate and fluorine-substituted organic sulfonic acid.

Any organic solvent may be used as long as it dissolves the electrolyte salt. Examples thereof include cyclic carbonates such as ethylene carbonate, propylene carbonate and butylene carbonate, cyclic esters such as γ-butyrolactone, ethers such as tetrahydrofuran and dimethoxyethane, and chain carbonates such as dimethyl carbonate, diethyl carbonate and ethyl methyl carbonate. These organic solvents may be used singly or as a mixture of two kinds or more.

The concentration of the electrolyte salt in the nonaqueous electrolytic solution is preferably in a range of 0.5 mol/l to 2.0 mol/l regardless of the kind of the electrolyte salt. When the concentration is less than 0.5 mol/l, electron conductivity of the solution may be reduced, while when the concentration is more than 2.0 mol/l, the number of free ions may be decreased by an ion-to-ion interaction to deteriorate the electron conductivity. The concentration is more preferably in a range of 0.8 mol/l to 1.5 mol/l.

The nonaqueous electrolytic solution may be used as a gel electrolyte with being impregnated into a polymer matrix. Inorganic and organic solid electrolytes may be used in addition to the electrolyte salt.

(Assembly of Secondary Battery)

A known method may be utilized for assembly of the secondary battery. For example, a laminate-type secondary battery may be produced in the following manner. First, the negative electrode and the positive electrode are cut into predetermined measurements and a separator is placed between the negative electrode and the positive electrode. Examples of the method of placing the separator include a method of wrapping the positive electrode with the separator. This work is repeated to laminate the desired number of sheets, which are fixed so that the negative electrode and the positive electrode of the laminated body do not shift. In addition to the laminated body, a wound body may be obtained by winding the negative electrode sheet, the separator and the positive electrode sheet.

Next, in order to collect the current from the negative electrode of the laminated body or the wound body, one end of a tab made of nickel is crimped or joined to the current collector of the negative electrode. Also, in order to collect the current from the positive electrode of the laminated body or the wound body, one end of a tab made of aluminum and nickel is crimped or joined to the current collector of the positive electrode. While placing the other end of the tab formed in the laminated body or the wound body so as to project out of a laminated film, the laminated body or the wound body is put in the laminated film and the film is sealed except for an electrolytic solution inlet. Such a structure allows continuity between the current collector tab and the external electrode. The nonaqueous electrolytic solution is injected in a predetermined amount into a laminate-type battery vessel thus produced and an electrolytic solution injection hole is finally sealed, whereby the secondary battery may be produced.

The above-mentioned description is a description of the laminate-type secondary battery; however, the present invention may apply to the secondary battery in any shape such as a cylinder, a rectangular parallelepiped, a coin or a card.

### EXAMPLES

Operation and effects of the present invention are specifically described hereinafter by referring to examples and comparative examples and contrasting them; however, the technical scope of the present invention is not limited by these examples and comparative examples.

However, the layer with increased resistance at high temperature described in the examples means the region in the layer in which the material with increased resistance at high temperature is contained by 90% at the weight ratio. Similarly, the negative electrode active material layer means the region in which the active material is contained by 90% or more. The mixed layer means the region in the active material layer except the layer with increased resistance at high temperature and the negative electrode active material layer.

The examples show the case of providing the negative electrode with a safety mechanism, and the same result is obtained even in the case of providing the positive electrode with the same mechanism.

### Influence on Battery Characteristic by Application of Material with Increased Resistance at High Temperature to Active Material Layer Surface

### Example 1

A producing method and a structure of the negative electrode in which a layer of the material with increased resistance at high temperature is imparted to the negative electrode active material layer surface are described in Example 1. A schematic view of the produced negative electrode is shown in FIG. 2.

Natural graphite (having an average particle diameter of 20 μm and a BET specific surface area of 3 m²/g) and artificial graphite (having an average particle diameter of 6 μm and a BET specific surface area of 17 m²/g) were used as the negative electrode active material and the conductive material, respectively. The negative electrode active material layer was formed out of a paste made by adding carboxymethyl cellulose (trade name: #2200, manufactured by Daicel Chemical Industries, Ltd.) as the thickening material and a styrene-butadiene rubber (trade name: TRD2001, manufactured by JSR Corporation) as the aqueous binder to the active material and the conductive material. The composition of these was active material:conductive material:thickening material:binder=100:10:1.5:2.

The layer of the material with increased resistance at high temperature was formed out of a paste composed of a high-polyethylene resin particle (softening point: 120° C., particle diameter: 3 μm, a resin that melts at high temperature) coated with gold (a conductive material) (hereinafter referred to as a gold-coated resin particle), artificial graphite (having an average particle diameter of 6 μm and a BET specific surface area of 17 m²/g) as the conductive material, carboxymethyl cellulose (trade name: #2200, manufactured by Daicel Chemical Industries, Ltd.) as the thickening material, and a styrene-butadiene rubber (trade name: TRD2001, manufactured by JSR Corporation) as the binder. The composition of these was gold-coated resin particle:conductive material:thickening material:binder=100:25:1.5:2.

The negative electrode active material paste was applied to and dried on a copper foil, on whose surface the material paste with increased resistance at high temperature was further applied and dried to thereby obtain a paste layer. A moderate pressure was uniformly applied to the obtained paste layer to produce a negative electrode having the structure as shown in FIG. 3. The thickness of the active material layer, the mixed layer and the layer of the material with increased resistance at high temperature was 45 μm, 5 μm and 10 μm respectively, and the average voidage of the negative electrode was 30%.

### Comparative Example 1

A negative electrode was produced in the following manner similarly to Example 1 except for uniformly intermingling an equivalent amount of the material with increased resistance at high temperature to that used in Example 1 in the whole active material.

First, the negative electrode active material paste and the material paste with increased resistance at high temperature were produced similarly to Example 1. The produced negative electrode active material paste and the material paste with increased resistance at high temperature were mixed at a volume ratio of 5:1 to produce a mixed paste. The obtained mixed paste was applied to and dried on a copper foil, to which a moderate pressure was thereafter applied uniformly to produce a negative electrode in which the negative electrode active material and the material with increased resistance at high temperature were uniformly mixed. However, the material composition of this negative electrode was active material:gold-coated resin particle:conductive material:thickening material:binder=100:20:15:1.8:2.4, and the negative electrode thickness was 60 μm and the voidage was 30%.

(Evaluations)

With regard to Example 1 and Comparative Example 1, the constitution of the negative electrode and the battery characteristic at 60° C. are shown in Table 1.

TABLE 1

| | | | | | Distribution | | | |
|---|---|---|---|---|---|---|---|---|
| | | | | Material | of material | | | |
| | | | | with | with | | | |
| | Negative | Negative | | increased | increased | 0.1C | | |
| | electrode | electrode | | resistance | resistance | discharge | Measured | |
| | current | active | Conductive | at high | at high | capacity | temperature | Resistance |
| | collector | material | agent | temperature | temperature | (mAh/g) | (° C.) | ratio |
| Example 1 | copper | natural | artificial | gold- | unevenly | 350 | 60 | 1 |
| | foil | graphite | graphite | coated | distributed | | | |
| | | | | resin | on active | | | |
| | | | | particle | material | | | |
| | | | | | layer | | | |
| | | | | | surface | | | |
| Comparative | copper | natural | artificial | gold- | mixed with | 350 | 60 | 1.8 |
| Example 1 | foil | graphite | graphite | coated | active | | | |
| | | | | resin | material | | | |
| | | | | particle | | | | |

It is found that Example 1 has the smaller electric resistance than Comparative Example 1. It is found from this fact that the negative electrode in which the material with increased resistance at high temperature was unevenly distributed on the negative electrode surface (in proximity to the separator) has little influence on the electric resistance.

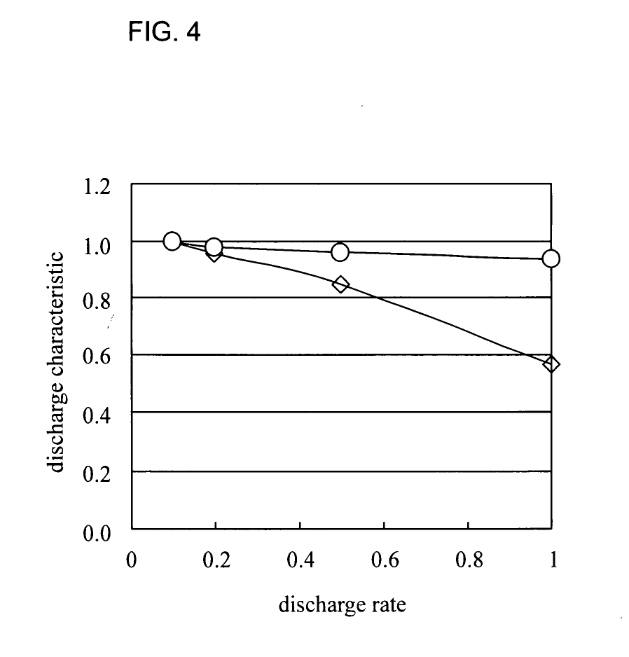

Also, with regard to Example 1 and Comparative Example 1, the discharge characteristic obtained from a single electrode test is shown in FIG. 4. It is found from FIG. 4 that Example 1 (a black circle) is superior in the discharge characteristic at 60° C. to Comparative Example 1 (an open rhombus).

The measurement in Table 1 and FIG. 4 was performed by the following method.

The evaluations of the produced negative electrode were performed in a three-electrode cell. Specifically, an Li metal was used for a counter electrode, an Li metal was used for a reference electrode, and a solution in which 1% of vinylene carbonate was dissolved in an ethylene carbonate-diethyl carbonate (1:2) mixed solution was used for the electrolytic solution. The resistance ratio was calculated from an IR drop in discharging.

### Voidage-Charge Characteristic

### Example 2

Too low a voidage of the active material layer makes an electrolytic solution content insufficient and affects the electric resistance greatly. Example 2 was performed for obtaining an optimum range thereof.

A negative electrode was produced in the same manner as in Example 1 except for modifying only the voidage into 2%, 20%, 40% and 50%.

With regard to Example 2, the constitution of the negative electrode is shown in Table 2.

TABLE 2

| | Negative | Negative | | | Distribution of |
|---|---|---|---|---|---|
| | electrode | electrode | | Material with | material with |
| | current | active | Conductive | increased resistance | increased resistance |
| | collector | material | agent | at high temperature | at high temperature |
| Example 2 | copper foil | natural | artificial | gold-coated resin | unevenly distributed |
| | | graphite | graphite | particle | on active material |
| | | | | | layer surface |

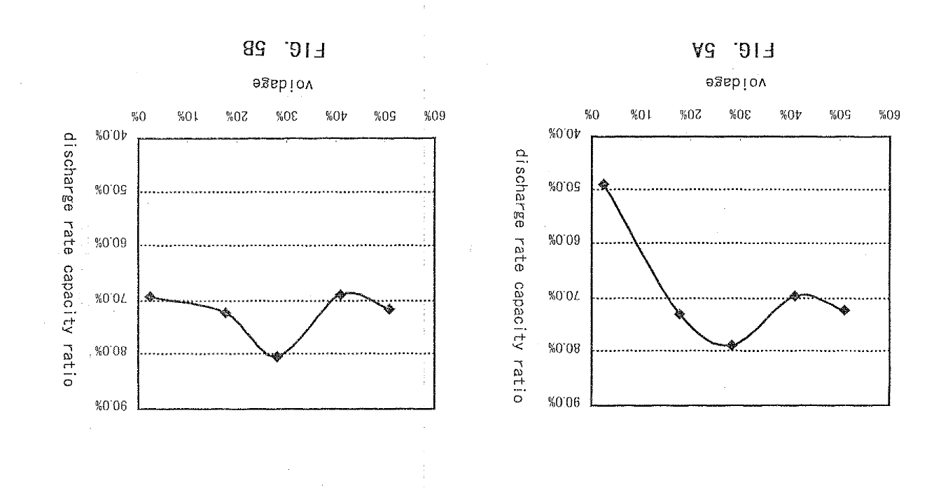

Here, a charge rate capacity ratio under a low output (low current:0.1 C) plotted with the voidage is shown in FIG. 5A. However, the charge rate capacity ratio means A/B×100(%) when the C rate for one charge and discharge in the single electrode test is regarded as c, and the capacity charged in (1/c) hour and the whole charging capacity are regarded as A (Ah) and B (Ah) respectively.

It is found from FIG. 5A that regardless of the voidage, in the case of the low output, the charge rate characteristic of approximately 70% or more is maintained and the obtained negative electrode has the normal characteristic.

Also, the charge rate capacity ratio under a high output (high current of 0.2 C) plotted with the voidage is shown in FIG. 5B. The high output means twice the output of the low output.

From FIG. 5B, a voidage less than 15% brings about a tendency of abruptly decreasing the charge rate capacity ratio. The reason therefor is conceived to be that the smaller voidage reduces the electrolytic solution content in the negative electrode to make the lithium ion migration less smooth. The inventors think that the voidage of 15% or more gives the sufficient charge characteristic. Therefore, in the case of operating the battery at the high output, it is found that the voidage of the active material layer is preferably 15% or more.

### Safety Mechanism

### Example 3

The resistance value between the negative electrode surface and the current collector at the normal temperature (approximately 25° C.) was measured for each of the negative electrode produced by the same method as in Example 1 and the negative electrode produced by the same method as in Example 1 except for providing no layer of the material with increased resistance at high temperature. Next, these negative electrodes were heated to 160° C. and the resistance value was measured in this state in the same manner as above.

As a result of measurement, the negative electrode with no layer of the material with increased resistance at high temperature provided exhibited no changes in the resistance value. On the contrary, with regard to the negative electrode of Example 1, heating to 160° C. melted the resin composing the layer of the material with increased resistance at high temperature, and the resistance value became three times as large as the resistance value at the normal temperature.

The resistance value was measured in the following manner.

The negative electrode having an external shape of a rectangle of 1 cm×2.5 cm and a copper foil exposed region of 0.5 cm×1 cm on a short side thereof was used for measuring the resistance value. The resistance value was obtained in such a manner that two arbitrary spots where the distance between the negative electrode surface and the copper foil exposed region was 2 cm were selected and the resistance value between the two spots were measured.

In the battery provided with the negative electrode with the layer of the material with increased resistance at high temperature provided, when the internal short circuit is caused due to mixing of a foreign matter and heat is generated, and the temperature of the short circuit region reaches the melting point of the resin material, the electric resistance of the material with increased resistance at high temperature in the region rises. Thus, the abnormal current due to the short circuit is restrained and further heat generation does not occur. That is to say, it is found that the safety mechanism as shown in FIGS. 1A to 1C is actuated.

From the above examples and comparative examples, it is found that the battery provided with the negative electrode with the layer of the material with increased resistance at high temperature provided may apply to the diverse battery structures, and improves the safety and does not deteriorate the battery characteristic.

What is claimed is:

1. A nonaqueous electrolyte secondary battery comprising:
a positive electrode;
a negative electrode; and
a separator between the positive electrode and the negative electrode; wherein
at least one of the positive electrode and the negative electrode has an active material layer containing a material whose electric resistance increases at a high temperature and
the material is unevenly distributed in proximity to the separator of the active material layer.

2. The nonaqueous electrolyte secondary battery according to claim 1, wherein the material is contained by 90% by weight or more of the total amount thereof in the active material layer within a thickness up to 30% from the separator side with respect to the total thickness.

3. The nonaqueous electrolyte secondary battery according to claim 1, wherein the material contains a conductive material and a resin that increases the electric resistance by melting at a high temperature.

4. The nonaqueous electrolyte secondary battery according to claim 1, wherein the material contains a resin that melts at a high temperature of at least 120° C. and at most 160° C.

5. The nonaqueous electrolyte secondary battery according to claim 1, wherein the material contains a particulate resin;
the active material layer contains a particulate active material; and
the resin has an average particle diameter of at most 10% of an average particle diameter of the active material and at most 50 μm.

6. The nonaqueous electrolyte secondary battery according to claim 1, wherein the material contains a conductive material selected from graphite, aluminum, stainless steel, titanium, copper, nickel and gold, and a resin that melts at a high temperature selected from polyethylene, polypropylene and a copolymer of ethylene and propylene.

7. The nonaqueous electrolyte secondary battery according to claim 1, wherein the active material layer has a voidage in a range of 15 to 80%.

8. The nonaqueous electrolyte secondary battery according to claim 1, wherein the material has an electric resistance at a temperature of at least 120° C. and at most 160° C. or, being at least three times larger than that at a temperature of at least −20° C. and at most 60° C.

9. The nonaqueous electrolyte secondary battery according to claim 1, wherein the material has an electric resistance of 0.05 to 10 Ω·cm at a temperature of −20° C. to 60° C.
